(19) United States
(12) Patent Application Publication
(10) Pub. No.: US 2025/0184898 A1
(43) Pub. Date: Jun. 5, 2025

(54) METHODS, DEVICES, AND MEDIUM FOR COMMUNICATION

(71) Applicant: NEC Corporation, Tokyo (JP)

(72) Inventors: Lei CHEN, Beijing (CN); Gang WANG, Beijing (CN)

(73) Assignee: NEC Corporation, Tokyo (JP)

(21) Appl. No.: 18/876,947

(22) PCT Filed: Jun. 21, 2022
(86) PCT No.: PCT/CN2022/100200

§ 371 Date: Dec. 19, 2024

(51) Int. Cl. H04W 52/02; H04W 56/00; H04W 68/02

(52) U.S. Cl. CPC H04W 52/0235; H04W 56/0015; H04W 68/02

(57) ABSTRACT

Example embodiments of the present disclosure relate to methods, devices, and computer storage medium for communication. A terminal device receives, in a low power (LP) mode and from a network device, an LP synchronization signal based on at least one of: an identity (ID) of a cell group of the network device, an ID of an LP-SS group of the network device, a tracking area ID associated with the network device, or a tracking area code associated with the network device; and detecting a wake-up signal from the network device based on the LP synchronization signal. As such, the terminal device can achieve and maintain the time synchronization with the network device in a certain precision, thus may utilize the synchronization to simplify the detection of wake-up signals, and enhance the detection performance.

### FIELD

Example embodiments of the present disclosure generally relate to the field of communication techniques and in particular, to methods, devices, and a computer readable medium for communication.

### BACKGROUND

Several technologies have been proposed for power saving of a terminal device. For example, a user equipment (UE) may enter to a radio resource control (RRC) idle/inactive state to reduce power consumption. However, it is still critical for power limited devices, e.g., the Internet of Things (IoT) devices, wearable devices, etc., since periodic paging monitoring and measurement consume considerable power at UE side even in RRC idle/inactive state. Therefore, it is beneficial for UE to further reduce the power consumption.

### SUMMARY

In general, example embodiments of the present disclosure provide methods, devices and a computer storage medium for communication.

In a first aspect, there is provided a method of communication. The method comprises: receiving, at a terminal device in a low power (LP) mode and from a network device, an LP synchronization signal based on at least one of: an identity (ID) of a cell group of the network device, an ID of an LP-SS group of the network device, a tracking area ID associated with the network device, or a tracking area code associated with the network device; and detecting a wake-up signal from the network device based on the LP synchronization signal.

In a second aspect, there is provided a method of communication. The method comprises: detecting, at a terminal device, a low power (LP) synchronization signal from a network device; determining, based on the detecting of the LP synchronization signal, a state of the terminal device relative to a coverage of the LP synchronization signal; and determining, based on the state, whether to wake up from an LP mode or whether to report the state to the network device.

In a third aspect, there is provided a method of communication. The method comprises: generating, at a network device, a low power (LP) synchronization signal based on at least one of: an identity (ID) of a cell group of the network device, an ID of an LP-SS group of the network device, a tracking area ID associated with the network device, or a tracking area code associated with the network device; and transmitting the LP synchronization signal to a terminal device in an LP mode.

In a fourth aspect, there is provided a terminal device. The terminal device comprises a processor and a memory. The memory is coupled to the processor and stores instructions thereon. The instructions, when executed by the processor, cause the terminal device to perform the method according to the first aspect or the second aspect above.

In a fifth aspect, there is provided a network device. The network device comprises a processor and a memory. The memory is coupled to the processor and stores instructions thereon. The instructions, when executed by the processor, cause the network device to perform the method according to the third aspect above.

In a sixth aspect, there is provided a computer readable medium having instructions stored thereon, the instructions, when executed on at least one processor, causing the at least one processor to carry out the method according to the first aspect or the second aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication system in which some embodiments of the present disclosure can be implemented;

FIG. 2A illustrates a schematic diagram of resources occupied by an LP signal which can be used in some example embodiments of the present disclosure;

FIGS. 2B-2C illustrate schematic diagrams of OOK symbols which can be used in some example embodiments of the present disclosure;

FIG. 3 illustrates a signalling chart illustrating communication process in accordance with some embodiments of the present disclosure;

FIG. 4 illustrates a schematic diagram of different periodicities of LP-SS and LP-WUS according to some embodiments of the present disclosure;

FIG. 5 illustrates a schematic diagram of different time durations for the LP-SS set according to some embodiments of the present disclosure;

FIG. 6 illustrates a schematic diagram of time resource for the LP-SS set according to some embodiments of the present disclosure;

FIG. 7 illustrates a schematic diagram of different LP-SS sets according to some embodiments of the present disclosure;

FIG. 8 illustrates a schematic diagram of time window for the LP-WUS according to some embodiments of the present disclosure;

FIG. 9 illustrates a schematic diagram of time window for the LP-WUS according to some embodiments of the present disclosure;

FIG. 10 illustrates a signalling chart illustrating communication process in accordance with some embodiments of the present disclosure;

FIG. 11 illustrates an example scenario according to some embodiments of the present disclosure;

FIG. 12 illustrates an example scenario according to some embodiments of the present disclosure;

FIG. 13 illustrates a flowchart of an example method in accordance with some embodiments of the present disclosure;

FIG. 14 illustrates a flowchart of an example method in accordance with some embodiments of the present disclosure;

FIG. 15 illustrates a flowchart of an example method in accordance with some embodiments of the present disclosure; and

FIG. 16 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHZ), FR2 (24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, for a UE in RRC idle/inactive state, the periodic paging monitoring and measurement consume considerable power at UE side, which is critical for the power limited devices such as IoT devices or wearable devices.

A lower power wake-up signal (LP-WUS) is proposed in Release 18, which may study and evaluate techniques of low power signals and low power receivers, to enable extreme low power consumption and low wake-up latency.

However, if a UE get into the Low Power Mode and switch off its main radio, the synchronization with the network side cannot be maintained based on primary synchronization signals (PSS), secondary synchronization signals (SSB) or tracking reference signals (TRS) any more. Therefore, configurations of synchronization signals for a UE in the low power mode should be studied and specified.

Embodiments of the present disclosure provide a solution of communication. In the solution, a low power synchronization signal (LP-SS) different from PSS/SSS is proposed, the LP-SS may be associated with information associated with a network device and may comprise an amplitude modulation sequence. As such, the synchronization with the network side in low power mode may be maintained and the communication efficiency may be improved. Principles and implementations of the present disclosure will be described in detail below with reference to the figures.

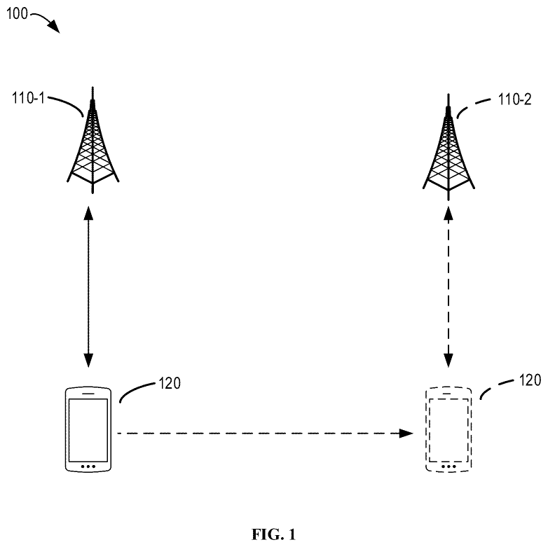

FIG. 1 illustrates an example communication system 100 in which some embodiments of the present disclosure can be implemented. The communication network 100 includes a network device 110-1 and an optionally network device 110-2 (collectively or individually referred to as network device(s) 110). The communication network 100 further includes a terminal device 120. The network device 110 can provide services to the terminal device 120.

In the system 100, it is assumed that the terminal device 120 is located within coverage of the network device 110-1. In some examples, a link from the network device 110-1 to the terminal device 120 is referred to as a downlink (DL), while a link from the terminal device 120 to the network device 110-1 is referred to as an uplink (UL). In downlink, the network device 110-1 is a transmitting (TX) device (or a transmitter) and the terminal device 120 is a receiving (RX) device (or a receiver). In uplink, the terminal device 120 is a transmitting TX device (or a transmitter) and the network device 110-1 is a RX device (or a receiver). In some embodiments, the network device(s) 110 and the terminal device 120 may communicate with direct links/channels. DL may comprise one or more logical channels, including but not limited to a Physical Downlink Control Channel (PDCCH) and a Physical Downlink Shared Channel (PDSCH). UL may comprise one or more logical channels, including but not limited to a Physical Uplink Control Channel (PUCCH) and a Physical Uplink Shared Channel (PUSCH). As used herein, the term “channel” may refer to a carrier or a part of a carrier consisting of a contiguous set of resource blocks (RBs) on which a channel access procedure is performed in shared spectrum.

In some cases, the terminal device 120 may move to the coverage of the network device 110-2 while out of coverage of the network device 110-1. In some embodiments, the network device 110-1 and the network device 110-2 may belong to a same cell group, or may be in different cell groups. In some embodiments, the network device 110-1 and the network device 110-2 may be with a same tracking area code (TAC), or may be with different tracking area codes.

In some embodiments, the terminal device 120 may be in a main mode. In the context of the present disclose, the terms “main mode”, “main radio”, “main receiver” can be used interchangeably. The terminal device 120 may perform normal DL/UL transmission in the main mode.

In some embodiments, the terminal device 120 may be in an idle/inactive mode. For example, the same coverage as the normal DL/UL transmission cannot be provided and the terminal device 120 may receive wake-up signals (WUS) with wake-up receivers (WUR).

In some embodiments, the primary target for the WUS or WUR may be power-sensitive, small form-factor devices including IoT use cases (such as industrial sensors, controllers) and wearables. In some examples, low-power wake-up receiver architectures may be studied and evaluated. In some examples, wake-up signal designs to support wake-up receivers may be studied and evaluated. In some examples, L1 procedures and higher layer protocol changes needed to support the wake-up signals may be studied and evaluated. In some examples, it is proposed to study potential UE power saving gains compared to the existing power saving mechanisms and their coverage availability, as well as latency impact. For example, system impact, such as network power consumption, coexistence with non-low-power-WUR UEs, network coverage/capacity/resource overhead may be included.

In some embodiments, the terminal device 120 may be in an LP mode. In the context of the present disclose, the terms “LP mode”, “low power mode”, “ultra-lower power mode”, “low power radio”, “ultra-lower power radio”, “low power receiver”, “ultra-lower power receiver” can be used interchangeably.

In the present disclosure, the term “low power (LP) mode” may refer to a mode that the terminal device 120 is not required to perform at least one of: paging monitoring, cell selection and re-selection, measurement based on SSB or channel state information-reference signal (CSI-RS), PDCCH monitoring, UL transmission, etc., and the terminal device 120 is required to perform LP signal monitoring and/or detection.

In some embodiments, the terminal device 120 may perform, when in a main mode, at least one of: paging monitoring, cell selection and re-selection, measurement based on SSB or CSI-RS, PDCCH monitoring, or UL transmission.

In some embodiments, the terminal device 120 may enter the LP mode by switching off the main radio. For example, the terminal device 120 is allowed to switch off its main radio and switch on its LP radio, wherein the LP radio is used to receive the LP signals and the main radio is used to receive or transmit the signals other than the LP signals.

In the present disclosure, the LP signal may include LP-SS and/or LP-WUS. In some embodiments, the LP-SS may be used for synchronization and measurement, and the LP-SS may be cell specific and may be an always-on signal. In some embodiments, the LP-WUS may be used for indicating the terminal device 120 to wake-up from the LP mode, and start to monitor paging information, and the LP-WUS may be UE group specific (or UE specific) and may be an on-demand signal.

As such, two types of LP signals are introduced, where the LP-SS may be used for synchronization while the terminal device 120 is in an LP mode.

In some embodiments, the LP-SS may be based on at least one amplitude modulation sequence, where the sequence may include a symbol with higher amplitude and a symbol with lower amplitude. In some examples, the amplitude modulation may include amplitude shift keying (ASK) or on-off keying (OOK) modulation. Specifically, on-off keying (OOK) modulation is widely considered due to its very simple receiver architecture and ultra-low power consumption. With OOK modulation, the receiver may only need to detect the envelop or energy of the time domain signal with a relatively low sampling rate, and without complicated baseband processing. As an example, the OOK modulation is considered in the following disclosure as one of the amplitude modulation. An OOK modulation sequence may include at least one OOK on-symbol and at least one OOK off-symbol. The present disclosure does not limit this aspect.

In some embodiments, the LP-WUS may be based on at least one amplitude modulation sequence, such as an OOK modulation sequence, or may be based on at least Gold sequence.

As such, the LP-SS may be based on at least one OOK modulation sequence, and thus the LP signal receiving may be facilitated. It is to be understood that the LP-SS is different from PSS or SSS. For example, the terminal device 120 may not need to achieve very precise time synchronization with the network side like the SSB/TRS does, since the OOK detection is more robust to time error than Orthogonal Frequency Division Multiplexing (OFDM) detection. For example, the terminal device 120 may not need to acquire at least the slot index and OFDM symbol index (or even sub-frame index), since they may be useless for OOK detection. Therefore, how to design the LP-SS and the related procedure is a critical issue.

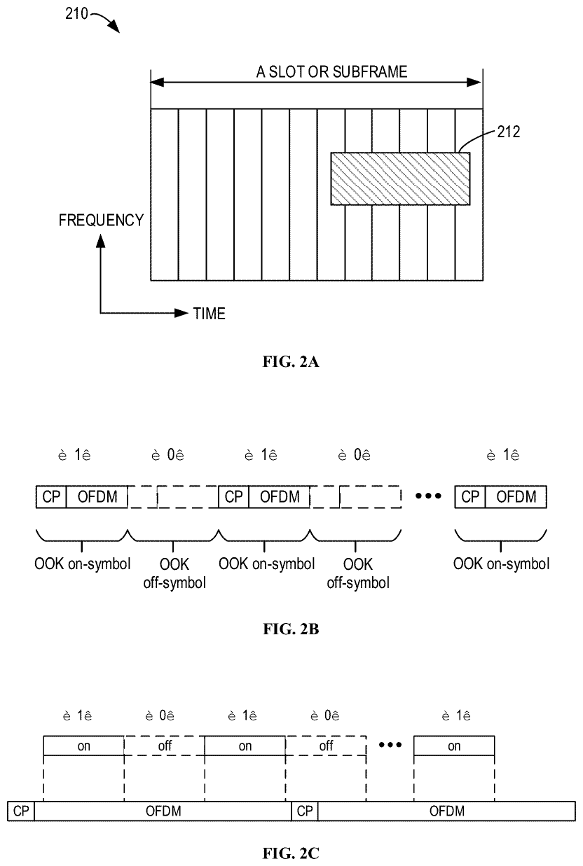

In some embodiments, an LP signal (LP-SS or LP-WUS) occupy a set of time/frequency resources for a serving cell. FIG. 2A illustrates a schematic diagram of resources 210 occupied by an LP signal which can be used in some example embodiments of the present disclosure. In frequency domain, the resources allocated to the LP signal 212 may be overlapped with a set of PRBs or subcarriers, i.e., the terminal device 120 may be indicated a set of PRBs or subcarriers, and the frequency resources of the set of PRBs or subcarriers are used by the LP signal 212. In time domain, the resources allocated to the LP signal 212 may be overlapped with a set of OFDM symbols, i.e., the terminal device 120 may be indicated a set of OFDM symbols, and the time resources of the set of OFDM symbols are used by the LP signal 212.

In some examples, OOK modulation is used to generate the LP signal, an OOK symbol can be an OOK on-symbol (denoted by logical “1”) or an OOK off-symbol (denoted by logical “0”), where the OOK on-symbol has a relatively high power, and the OOK off-symbol has zero power or relatively low power.

It is to be understood that the OOK symbol may be equal to or may be not equal to an OFDM symbol. FIGS. 2B-2C illustrate schematic diagrams of OOK symbols which can be used in some example embodiments of the present disclosure.

As shown in FIG. 2B, an OOK on-symbol or an OOK off-symbol may have a duration which equals to the duration of an OFDM symbol. In this case, an OOK on-symbol and an OOK off-symbol are realized by a non-zero power OFDM symbol and a zero power OFDM symbol respectively.

As shown in FIG. 2C, an OOK on-symbol or an OOK off-symbol may have a duration which is shorter than an OFDM symbol. In this case, the OOK on-symbol and OOK off-symbol can be realized by DFT-s-OFDM, or by independent time domain generation.

In some embodiments, an LP signal may include a sequence of OOK symbols which is formed by at least one OOK on-symbol and at least one OOK off-symbol, e.g., “1010 . . . 1” as shown in FIGS. 2B-2C.

Please note that, in the present disclosure, if not specified otherwise, the term “OFDM symbol” indicates CP-OFDM symbol, or any variant of OFDM symbol, e.g., GI-OFDM, zero CP OFDM, unique word OFDM, etc.

In some embodiments, the OOK on-symbol has a higher power, and the OOK off-symbol has a lower power. In the context of the present disclose, the terms “power”, “energy”, “amplitude”, “strength” may be used interchangeably.

Communications in the system 100, between the network device 110-1 and the terminal device 120 for example, may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

It is to be understood that the numbers of devices (i.e., the network devices 110 and the terminal device 120) and their connection relationships and types shown in FIG. 1 are only for the purpose of illustration without suggesting any limitation. The system 100 may include any suitable numbers of devices adapted for implementing embodiments of the present disclosure.

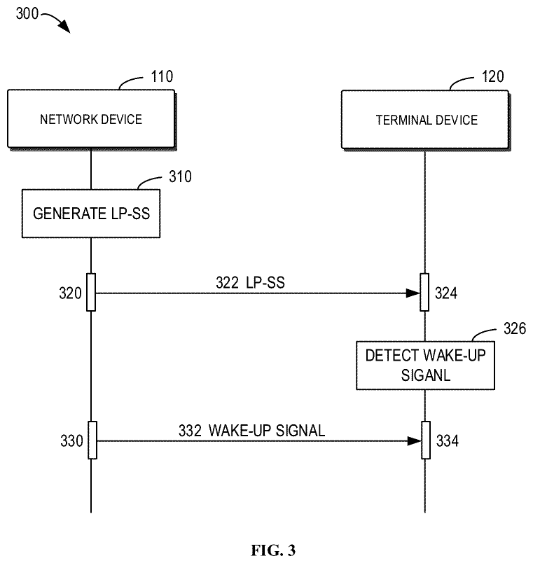

Embodiments of the present disclosure where the terminal device can receive an LP-SS in an LP mode. Reference is first made to FIG. 3, which illustrates a signalling chart illustrating communication process 300 in accordance with some example embodiments of the present disclosure. Only for the purpose of discussion, the process 300 will be described with reference to FIG. 1. The process 300 may involve the terminal device 120, the network device 110 (for example the network device 110-1 or the network device 110-2).

In the present disclosure, two types of LP signals are proposed: LP-SS and LP-WUS. The LP-SS may be used for synchronization, measurement, and/or beam measurement. The LP-SS may be cell specific, or cell group specific (e.g., cells associated with same TAC, i.e., tracking area code, can have same configuration for LP-SS). And the terminal device 120 may expect the LP-SS will always be transmitted in each LP-SS occasion. The LP-WUS may be used for informing the terminal device 120 the wake-up information, e.g., to inform the terminal device 120 to wake-up from the LP mode, or inform the terminal device 120 to stay in the LP mode, or to inform the terminal device 120 new configuration for LP-SS.

As illustrated in FIG. 3, the network device 110 generates 310 an LP synchronization signal (LP-SS). In some embodiments, the LP-SS is different from a PSS or a SSS.

In some example embodiments, the LP-SS may comprise a amplitude modulation sequence, for example, the LP-SS may comprise an OOK sequence, which include at least one OOK on-symbol and at least one OOK off-symbol.

In some embodiments, a sequence for the LP-SS may be generated based on at least one amplitude modulation sequence (such as an OOK sequence) which is associated with an identity, where the identity is associated with the network device 110. In some examples, the identity may be at least one of: an identity (ID) of a cell of the network device 110, an ID of a cell group of the network device 110, an ID of an LP-SS group of the network device 110, a tracking area ID associated with the network device 110, a tracking area code associated with the network device 110, or an indication provided by the network device 110 for indicating the LP-SS.

In some embodiments, a sequence for the LP-SS may be generated based on more than one amplitude modulation sequence, for example, based on a first OOK sequence and a second OOK sequence, where at least one of the first and the second OOK sequence is associated with the identity.

In some example embodiments, the LP-SS may be one of a plurality of signals associated with a plurality of transmit beams of the network device or Quasi-Co-Located (QCLed) with a plurality of SSBs to be transmitted by the network device 110, respectively. In some examples, the network device 110 may configure to the terminal device 120 an LP-SS set including the plurality of signals.

In some embodiments, the plurality of signals in the LP-SS set may be based on a common amplitude modulation sequence. In some examples, the plurality of signals in the LP-SS set may be represented as a same sequence, and may be transmitted with different time resources. For examples, different time resources refer to different sub-frames within a system frame.

In some embodiments, the plurality of signals in the LP-SS set may be based on different amplitude modulation sequences. In some examples, each of the plurality of signals may be associated with at least one of: a sub-frame index, a slot index, or an index of the plurality of signals. For example, different signals in the LP-SS set are associated with different sub-frame indexes. For example, different signals in the LP-SS set are associated with different slot indexes. For example, each of the plurality of signals is associated with an index of the LP-SS set (i.e., the index of the plurality of signals).

In some examples, different signals in the LP-SS set may be associated with different signal indexes.

In some embodiments, the network device 110 may generate the LP-SS based on its TX beam and the LP-SS set.

Alternatively of additionally, the network device 110 may configure or indicate to the terminal device 120 a set of time resources of the LP-SS. In some embodiments, the network device 110 may indicate a set of time resources to the terminal device 120 by at least one of: an initial hyper frame number, a transmission periodicity of the LP synchronization signal, a hyper frame offset, a frame offset, a sub-frame offset, or a slot offset. In some examples, the transmission periodicity may equal to a plurality of hyper frames or a plurality of frames.

For example, the network device 110 may transmit an indication of the initial hyper frame number to the terminal device 120, where the indication of the initial hyper frame number may be transmitted by system information, RRC signalling or a packet data convergence protocol (PDCP) parameter.

The network device 110 transmits 320 the LP-SS 322 to a terminal device 120. In some example embodiments, the network device 110 may transmit the LP-SS 322 on one of the set of time resources. In some example embodiments, the LP-SS 322 may be one of the plurality of signals corresponding to the TX beam, where the LP-SS 322 is transmitted through the TX beam.

On the other side of the communication, the terminal device 120 in an LP mode receives 324 the LP-SS 322.

Alternatively of additionally, the terminal device 120 may enter the LP mode from the main mode. In some examples, the terminal device 120 may receive control information informing the terminal device 120 to enter the LP mode, and the terminal device 120 may enter the LP mode based on the control information.

In some embodiments, the terminal device 120 may enter the LP mode by switching off the main mode. And the terminal device 120 may not be required to perform at least one of: paging monitoring; cell selection or re-selection; measurement based on a PSS, a SSS or a CSI-RS; PDCCH monitoring; or an uplink transmission.

In some example embodiments, the terminal device 120 may receive the LP-SS 322 based on the identity which is associated with the LP-SS 322. In some examples, the identity may be at least one of: an ID of a cell of the network device 110, an ID of a cell group of the network device 110, an ID of an LP-SS group of the network device 110, a tracking area ID associated with the network device 110, a tracking area code associated with the network device 110, or an indication provided by the network device 110 for indicating the LP-SS.

In some example embodiments, the LP-SS 322 is one of a plurality of signals associated with a plurality of transmit beams of the network device 110 or QCLed with a plurality of SSBs to be transmitted by the network device 110, respectively. In this case, the terminal device 120 may determine a TX beam or an index of SSB, based on the received LP-SS 322.

Alternatively of additionally, the terminal device 120 may determine a set of time resources, and receive the LP-SS 322 on one of the set of time resources.

In some example embodiments, the set of time resources may be determined based on at least one of: a hyper frame number (HFN), a transmission periodicity of the LP synchronization signal, a hyper frame offset, a frame offset, a sub-frame offset, or a slot offset.

In some embodiments, the transmission periodicity may be equal to a plurality of hyper frames. In some embodiments, the terminal device 120 may determine the HFN based on an initial hyper frame number.

In some examples, the terminal device 120 may receive an indication of the initial hyper frame number in a serving cell before entering the LP mode. It is noted that the indication of the initial hyper frame number may be transmitted from the serving cell, while the terminal device 120 is in a main model; and the network device in the serving cell may be the network device 110 or may be another one different from the network device 110, the present disclosure does not limit this aspect.

In some examples, the terminal device 120 may determine the initial hyper frame number based on an instant when control information is received by the terminal device 102, where the control information instructs the terminal device 120 to enter the LP mode.

In some embodiments, the terminal device 120 may determine that the HFN equals to the initial hyper frame number firstly, and then the HFN is updated by increasing 1 if a system frame number (SFN) is changed from 1023 back to 0.

In some embodiments, the transmission periodicity may be equal to a plurality of frames. In some examples, the set of time resources may be determined further based on an ID of LP-SS group which includes the LP-SS 322. The LP-SS group includes at least one LP-SS. In some examples, the ID of the LP-SS group may be an index of the LP-SS group. In some examples, the LP-SS group may be implemented as an LP-SS set and the present disclosure does not limit this aspect. As mentioned above, the LP signal may include the LP-SS 322 and/or at least one LP-WUS 332. In some examples, in case the LP signal includes the LP-SS 322 and at least one LP-WUS 332, the ID of the LP-SS group may be equal to ID of LP signal group which include the LP signal. In some examples, in case the LP signal includes the LP-SS 322, the ID of the LP-SS group may be equal to the ID of the LP signal group.

As such, the terminal device 120 may achieve and maintain the time synchronization with the network device 110 in a certain precision.

The network device 110 transmits 330 a wake-up signal 332 to the terminal device 120. In some embodiments, the wake-up signal 332 may be UE specific or UE group specific, and may be an on-demand signal. As such, the overhead may be reduced.

In some examples, the network device 110 may generate a wake-up signal 332 based on an ID of the terminal device 120, or an ID of a group which the terminal device 120 belongs to, or an ID associated with the terminal device 120 and indicated by the network device 110. In some examples, the wake-up signal 322 may also be called as a low power wake up signal (LP-WUS) and the present disclosure does not limit this aspect.

In some example embodiments, the wake-up signal 332 may inform the terminal device 120 of at least one of: staying in the LP mode, waking up from the LP mode, or a configuration of an LP-SS to be transmitted by the network device 110.

In some example embodiments, the wake-up signal 332 may be transmitted at one of a plurality of occasions within a window.

Alternatively or additionally, the network device 110 may configure or indicate the window to the terminal device 120. For example, a starting point and a period length of the window may be indicated to the terminal device 120.

In some embodiments, the plurality of occasions may be associated with a plurality of LP-SSs, for example, the plurality of occasions may be associated with the plurality of signals in an LP-SS set as described above. In some examples, there may be N LP-SS signals in the LP-SS set and there may be N occasions in the window, and the ith occasion may be associated with the ith LP-SS signal, where N is an integer, i is an integer between 0 and N.

In some example embodiments, the wake-up signal 332 may be transmitted through a TX beam the same as that for the LP-SS 322.

The terminal device 120 detects 326 the wake-up signal based on the received LP-SS 322. And alternatively, the terminal device 120 receives 334 the wake-up signal 332.

In some example embodiments, the wake-up signal 332 at the one of a plurality of occasions is associated with the LP-SS 322 in a plurality of signals, and an order of the one of a plurality of occasions among the plurality of occasions is the same as an order of the LP-SS 322 in the plurality of signals. In some examples, if the terminal device 120 receives the ith LP-SS in the plurality of signals, the terminal device 120 may expect a wake-up signal at the ith occasion of a plurality of occasions, and accordingly the terminal device 120 detects a wake-up signal at the ith occasion, where i is an integer.

As such, the terminal device 120 may utilize the synchronization achieved by the LP-SS 322 to simplify the detection of wake-up signal 322, and the detection performance may be enhanced.

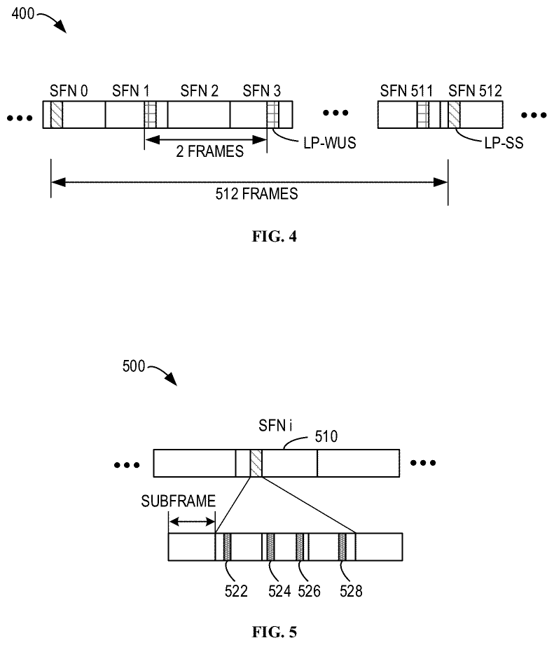

For better understanding, some detailed descriptions are stated below with reference to FIGS. 4-12.

In some example embodiments, the network device 110 may generate the LP-SS 322 based on information associated with the network device110. Accordingly the terminal device 120 may receive the LP-SS 322 based on the information associated with the network device110. In some embodiments, the information associated with the network device110 may include at least one of: an identity (ID) of a cell of the network device 110, an ID of a cell group of the network device 110, an ID of an LP-SS group of the network device 110, a tracking area ID associated with the network device 110, a tracking area code associated with the network device 110, or an indication provided by the network device 110 for indicating the LP-SS.

In some examples, the ID of a cell of the network device 110 may be represented as a Cell-ID, the ID of a cell group of the network device 110 may be represented as a Cell-group ID, the ID of an LP-SS group of the network device 110 may be represented as an LP-SS group ID.

For example, the LP-SS 322 may be based on the tracking area code (TAC) which may be associated with a group of network devices. As such, the LP-SS does not change even if the terminal device 120 moves from a cell to another cell, as long as it remains in the group of network devices associated with the TAC. Therefore, singnalling overhead and power consumption due to the LP-SS reconfiguration may be reduced and communication efficiency may be improved.

It is to be understood that the information associated with the network device 110 in the present disclosure may be in other form, such as a value or an integer or an index indicated by the network device 110, for example, the information associated with the network device 110 may be called as an identity, and the present disclosure does not limit this aspect.

In some embodiments, the LP-SS 322 may be based on at least one sequence, which may be represented as dₗₚₛₛ. The at least one sequence may be informed by network (such as the network device 110 or a core network function), or be determined based on an identity, where the identity may be a Cell-ID, a Cell-group ID, an LP-SS group ID, a tracking area ID, a tracking area code, or an integer indicated by the network device 110. If the terminal device 120 is configured with multiple identities, the terminal device 120 may determine multiple sequences for LP-SS.

In some examples, a sequence for LP-SS (sequence dₗₚₛₛ) may be generated based on at least one m-sequence, where the sequence dₗₚₛₛ is used to generate LP-SS. For example, m-sequence may be represented as x (m), and the sequence dₗₚₛₛ may be defined by

$${d}_{lpss} ( n ) = 1 - 2 x ( m ) , m = ( n + {a}_{1} {N}_{D} ) mod {a}_{2} \qquad ( 1 )$$

with 0≤n<a₂.

In the above equation, a₁ and a₂ may be fixed values. As an example, if a₂=31, it may define that

$$x ( i + 5 ) = ( x ( i + 2 ) + x ( i ) ) mod 2 , \qquad ( 2 )$$

$$[ \begin{matrix}x ( 4 ) & x ( 3 ) & x ( 2 ) & x ( 1 ) & x ( 0 )\end{matrix} ] = [ \begin{matrix}{b}_{4} & {b}_{3} & {b}_{2} & {b}_{1} & {b}_{0}\end{matrix} ] . \qquad ( 3 )$$

As another example, if a₂=63, it may define that

$$x ( i + 6 ) = ( x ( i + 3 ) + x ( i ) ) mod 2 \qquad ( 4 )$$

$$[ \begin{matrix}x ( 5 ) & x ( 4 ) & x ( 3 ) & x ( 2 ) & x ( 1 ) & x ( 0 )\end{matrix} ] = [ \begin{matrix}{b}_{5} & {b}_{4} & {b}_{3} & {b}_{2} & {b}_{1} & {b}_{0}\end{matrix} ] . \qquad ( 5 )$$

In the above equation, a₁ and a₂ are two integers, and a₂ may be equal to the length of the sequence. Each of b₅, b₄, b₃, b₂, b₁, b₀ may be 0 or 1. N_{ID} may be an integer which is associated with an identity, and the identity may be a Cell-ID, a Cell-group ID, an LP-SS group ID, a tracking area ID, a tracking area code, or an integer indicated by the network device 110, as discussed above.

In some examples, the identity may be represented as C_{ID}, in other words, using C_{ID} to denote the identity which N_{ID} is associated with, where C_{ID} is an integer, then the N_{ID} can be determined by any one of the following equations:

$${N}_{ID} = {C}_{ID} mod ( {a}_{2} / {a}_{1} ) , \qquad ( 6 )$$

$${N}_{ID} = {C}_{ID} mod [ floor ( {a}_{2} / {a}_{1} ) ] , \qquad ( 7 )$$

$${N}_{ID} = {C}_{ID} mod [ ceil ( {a}_{2} / {a}_{1} ) ] . \qquad ( 8 )$$

In the equations (6)-(8), floor ( ) is a function that gives the largest integer less than or equal to input as output, and ceil ( ) is a function that gives the smallest integer larger than or equal to input as output.

As shown in the above examples, the initialization values of m-sequence (such as [b₄ b₃ b₂ b₁ b₀] in equation (3) or [b₅ b₄ b₃ b₂ b₁ b₀] in equation (5)) are fixed values. However, it is to be understood that the initialization values of m-sequence (also referred to as initialization sequence) may also be associated with the identity (C_{ID}). For example, the initialization sequence may be equal to the binary format of the identity, or the first or last multiple binary digits of the identity, or equal to binary format of (C_{ID} mod A), where A is an integer.

As an example, a₂=31, a₁=10, [b₄ b₃ b₂ b₁ b₀]=[1 0 1 1 0], and N_{ID}=0, 1, or, 2. As another example, a₂=63, a₁=10, [b₅ b₄ b₃ b₂ b₁ b₀]=[1 1 0 1 1 0], and N_{ID}=0, 1, 2, 3, 4, or 5.

It is to be understood that the above description is only for the purpose of illustration without suggesting any limitation as to the scope of the disclosure.

In some examples, a sequence for LP-SS (represented as a sequence dₗₚₛₛ) may be generated based on more than one m-sequence. For example, there are two m-sequences: x₁(m) and x₂(m), and the sequence for LP-SS (sequence dₗₚₛₛ) may be defined as

$${d}_{lpss} ( n ) = [ 1 - 2 {x}_{1} ( m ) ] [ 1 - 2 {x}_{2} ( m ) ] \qquad ( 9 )$$

$$or {d}_{l p s s} ( n ) = [ {x}_{1} ( m ) + {x}_{2} ( m ) ] mod 2. \qquad ( 10 )$$

In some embodiments, the m-sequence may also be based on an ID of an LP-SS set. In some embodiments, the m-sequence may also be based on an index of the LP-SS in the LP-SS set, or a sub-frame index or a slot index associated with the LP-SS.

As stated above, the LP signal may include LP-SS and/or LP-WUS. In some embodiments, the LP-WUS may be based on information associated with the terminal device 120. In some examples, the information associated with the terminal device 120 may include at least one of: an ID of the terminal device 120, an ID of a group of the terminal device 120, or an indication provided by the network device 110 for indicating the LP-WUS. In some examples, the ID of the terminal device 120 may be represented as a UE-ID, the ID of a group of the terminal device 120 may be represented as a UE group ID, and an indication provided by the network device 110 for indicating the LP-WUS may be represented as an ID indicated by the network device 110.

In some embodiments, the LP-WUS may be based on at least one candidate sequence similarly. In some examples, the at least one candidate sequence for LP-WUS is used to inform the terminal device 120 to wake-up from the LP mode (i.e., to start receiving or transmitting a certain type of physical channel/signal, e.g., PDCCH, Paging, etc.), or to inform the terminal device 120 not to wake-up, i.e., do not receive or transmit a certain type of physical channel/signal. The at least one candidate sequence is determined based on the UE-ID or UE group ID, or an ID indicated by the network device 110. As such, the terminal device 120 may be indicated with multiple IDs to determine multiple sequences for LP-WUSs.

Alternatively, the at least one candidate sequence may be determined based on the paging configuration, e.g., the sequence is associated with an index of the paging frame, or the index of a paging occasion.

In some examples, the at least one candidate sequence may be at least one m-sequence or Gold sequence which is generated based on a UE-ID or a UE group ID.

Alternatively or additionally, the LP-SS and the LP-WUS may share same frequency domain configuration. For example, the LP-SS and the LP-WUS may occupy the same frequency domain resources. In this event, the complexity at the terminal device 120 may be reduced and the power consumption can be reduced.

Alternatively or additionally, the LP-SS and the LP-WUS may be configured with different time domain configurations. Specifically, they may be configured with different periodicities.

For better understanding, reference is now made to FIG. 4, which illustrates a schematic diagram of different periodicities 400 of LP-SS and LP-WUS according to some embodiments of the present disclosure. As shown in FIG. 4, the LP-SS may have a periodicity of 512 system frames or 5.12 seconds, and the LP-WUS may have a periodicity of 2 system frames or 20 ms.

In some examples, in case an LP-SS and an LP-WUS are overlapped or partially overlapped in time domain, the terminal device 120 may determine (or assume) that the LP-WUS is not transmitted.

It is to be understood that the periodicity here in only for purpose of illustration without limitation, and some detailed descriptions about the periodicity for LP-SS are described below.

In some embodiments of the present disclosure, the LP-SS may be one of a plurality of signals associated with a plurality of transmit beams of the network device 110 or Quasi-Co-Located (QCLed) with a plurality of synchronization signal blocks (SSB) to be transmitted by the network device 110, respectively.

In this case, the LP-SS may be used for beam based transmission. For example, it is assumed that the LP receiver may use a passive omnidirectional antenna, i.e. no RX beams, and thus beam management based on LP-SS may be supported. In some examples, there may be only one RX beam at the terminal device 120.

In some embodiments, the network device 110 may configure the plurality of signals associated with a plurality of TX beams or QCLed with a plurality of SSBs to be transmitted by the network device 110, respectively. In some examples, the plurality of signals may be referred to as an LP-SS set. The network device 110 may configure the LP-SS set to the terminal device 120, and the LP-SS set may include one or more LP-SSs.

In some example embodiments, the LP-SS set may be confined within a system frame. In other words, the plurality of signals are not cross a boundary of two contiguous system frames, and thus a same system frame number (SFN) is associated with the LP-SS set. As such, a same SFN may be determined based on the LP-SS set regardless of TX beams. In other words, all the LP-SSs in the LP-SS set are associated with a same SFN and the terminal device 120 may determine the SFN no matter which LP-SS it detected.

In some example embodiments, the plurality of signals in the LP-SS set may be utilized for beam measurement.

In some examples, the LP-SS set includes the plurality of signals (also refer to a plurality of LP-SSs), and each of the plurality of signals is associated with a TX beam, or is QCLed with a SSB (for example, associated with a SSB index). In some examples, the terminal device 120 may also refine its RX beam based on the plurality of signals (if any). This is beneficial for the terminal device 120 to quicken its beam measurement after waking-up since it may be not needed to blind detect all the SSBs to find a better beam.

In some embodiments, the plurality of signals in the LP-SS set may be based on a same sequence. For example, the plurality of signals may be regarded as N times repetition of an LP-SS.

In some examples, the index of an LP-SS (such as an order) in the LP-SS set may be determined based on the time resource of the LP-SS. For example, assume that there are N LP-SSs in the LP-SS set with index 0 to index N−1, and assume that the N LP-SSs occupy N different time durations (such as different sub-frames), if the terminal device 120 receive an LP-SS at the nth sub-frame of the N different sub-frames, then the terminal device 120 may determine that the received LP-SS with an index n−1.

For better understanding, reference is now made to FIG. 5, which illustrates a schematic diagram of different time durations 500 for the LP-SS set according to some embodiments of the present disclosure. As shown in FIG. 5, a frame 510 with SFNi is used for transmitting LP-SSs and there are 4 time durations 522-528 for 4 LP-SSs. If the terminal device 120 receives an LP-SS at time duration 522, it can determine the index of the received LP-SS as “0”. If the terminal device 120 receives an LP-SS at time duration 526, it can determine the index of the received LP-SS as “2”.

As such, the terminal device 120 may only need to blind detect one LP-SS, therefore the complexity of the terminal device 120 may be reduced.

In some embodiments, the plurality of signals in the LP-SS set may be based on different sequences. For example, each of the plurality of signals may be associated with an index of the LP-SS set. In addition, each of the plurality of signals is associated with a sub-frame index or a slot index. As such, the terminal device 120 may determine to which LP-SS set the received LP-SS belongs based on the associated index of the LP-SS set. And the terminal device 120 may determine which specific signal is received based on the associated sub-frame index or slot index.

In some examples, N_{ID} as shown in equation (1) may also be associated with the index of the LP-SS in an LP-SS set, or the index of the sub-frame or slot index of the LP-SS.

As such, the terminal device 120 may determine the sub-frame index or slot index based on the index of the LP-SS it detected, although the terminal device 120 needs to detect more than more LP-SSs.

With the LP-SS, the terminal device 120 can achieve and maintain the time synchronization with the network side in a certain precision, thus the terminal device 120 may utilize the synchronization to simplify the detection of LP-WUS, and enhance the detection performance.

In some example embodiments, the terminal device 120 may be indicated a transmission periodicity of the LP-SS. In some embodiments, the transmission periodicity may also be regarded as a periodicity of the LP-SS set.

In some example embodiments, the periodicity may be equal to a plurality of hyper frames. For example, the periodicity may be N1 hyper frames, where a hyper frame comprises 1024 frames with indices from SFN 0 to SFN 1023, N1 is an integer larger than zero.

In some embodiments, the terminal device 120 may also be indicated at least one of: a hyper frame offset n1, a frame offset n2, a sub-frame offset n3, and a slot offset n4.

In some examples, a periodicity N1, a hyper frame offset n1 and a frame offset n2 are indicated, and the LP-SS set may be transmitted in a system frame with SFN n2 of a hyper frame with HFN n, and (n mod N1)=n1.

In some examples, the terminal device 120 may receive an initial HFN from the serving cell before entering into LP mode, the initial HFN may be indicated by system information, or RRC signalling, or PDCP parameter(s). And the terminal device 120 may maintain the counting of HFN after entering into LP mode. In some other examples, the terminal device 120 may determine the initial HFN based on the time point that control information is received, where the control information indicates the terminal device 120 to enter into the LP mode. Specifically, if the control information is received in a system frame with SFN i, then the terminal device 120 may determine the current hyper frame which the SFN i belongs to is an initial hyper frame and the associated initial HFN is a predefined integer, e.g., 0, 512, or 1023. And the terminal device 120 may maintain the counting of HFN after entering into LP mode.

In some examples, a periodicity N1=1 and a frame offset n2 are indicated, and the LP-SS set may be transmitted in a system frame with SFN n2 of each hyper frame.

In some examples, a sub-frame offset n3 is also indicated, and the LP-SS set may be transmitted in the sub-frame n3 of the system frame with SFN n2.

In some examples, a slot offset n4 is also indicated, and the LP-SS set may be transmitted in the slot n4 of the sub-frame n3.

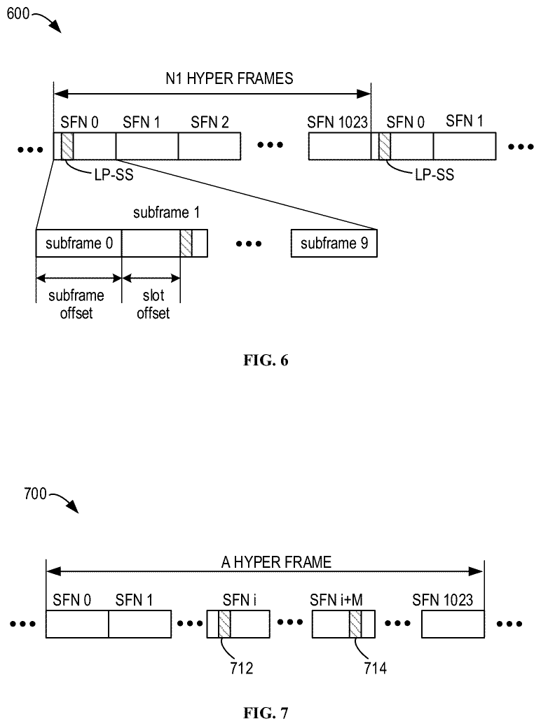

For better understanding, reference is now made to FIG. 6, which illustrates a schematic diagram of time resource 600 for the LP-SS set according to some embodiments of the present disclosure. As shown in FIG. 6, assume that N1 is indicated, and assume that n1=0, n2=0, n3=1 and n4 are all indicated, then the time resource 600 may be determined in sub-frame 1 of frame 0.

In some example embodiments, the SFN for transmitting the LP-SS may be pre-configured or pre-indicated. In some examples, the LP-SS set may be transmitted in at least one predetermined system frame (e.g., SFN 0 or 1), no matter in which cell it is transmitted. As such, the terminal device 120 may assume that the LP-SSs are always transmitted in the pre-determined system frame(s), and it is beneficial for detecting unknown LP-SS(s).

Alternatively of additionally, the terminal device 120 may also be indicated a set of OFDM symbols in a sub-frame or in a slot, and the LP-SS may occupy the time resource overlapped with the set of OFDM symbols.

As such, the terminal device 120 may obtain or maintain the HFN, SFN, sub-frame index, slot index and/or OFDM symbol index based on the detection timing of the LP-SS.

It is to be understood that, there will be at most one LP-SS set in a hyper frame since the periodicity is N1 hyper frames, it is not necessary for the terminal device 120 to distinguish different LP-SS sets. In some embodiments, the LP-SS sets may be the same with each other, for example, there may be a first LP-SS set including N LP-SSs and a second LP-SS set including N LP-SSs, and the ith LP-SS in a the first LP-SS set is the same as the ith LP-SS in the second LP-SS set, where i is an integer between 0 and N. As such, the complexity at the terminal device 120 may be reduced and the power consumption may be also reduced.

In some example embodiments, the periodicity may be equal to a plurality of frames. For example, the periodicity may be M frames, where M may be an integer between 0 and 1023. In other words, the periodicity may be shorter than a hyper frame.

In some embodiments, the terminal device 120 may also be indicated at least one of: a frame offset m1, a sub-frame offset m2, and a slot offset m3.

In some examples, a periodicity M and a frame offset m1 are indicated, and the LP-SS set may be transmitted in a system frame with SFN m0, and (m0 mod M)=m1. In some examples, the terminal device 120 may assume that the LP-SS set is appeared in any sub-frame or slot in the system frame m0.

In some examples, a sub-frame offset m2 is also indicated, and the LP-SS set may be transmitted in a sub-frame with index m2 in the frame with SFN m0.

In some examples, a slot offset m3 is also indicated, and the LP-SS set may be transmitted in a slot with index m3 in the sub-frame with index m2 in the frame with SFN m0.

Alternatively of additionally, the terminal device 120 may also be indicated a set of OFDM symbols in a sub-frame or slot, and the LP-SS may occupy the time resource overlapped with the set of OFDM symbols.

It is to be understood that, there will be more than one LP-SS set in a hyper frame since the periodicity is less than a hyper frame. In some embodiments, different LP-SS sets in a hyper frame may be associated with different indexes, as such, the set of time resources for the LP-SS may be determined based on the index of an LP-SS group (or the LP-SS set).

FIG. 7 illustrates a schematic diagram of different LP-SS sets 700 according to some embodiments of the present disclosure. As shown in FIG. 7, a first LP-SS set 712 is at a frame with SFN i, and a second LP-SS set 714 in at a frame with SFN i+M, within a hyper frame 710.

Assuming there are T LP-SS sets in a hyper frame (e.g., T=1024/M), in order to enable the terminal device 120 to determine the SFN number, the LP-SSs in different LP-SS sets should be different. For example, the ith LP-SS in a first LP-SS set is different from the ith LP-SS in a second LP-SS set, among the T LP-SS sets, where i is an integer. In some examples, the sequence of the LP-SS may be generated also based on the index of the LP-SS set in the T LP-SS sets.

As such, the terminal device 120 may obtain the SFN, sub-frame index, slot index and/or OFDM symbol index based on the detection timing of the LP-SS.

In some examples, m-sequence (as shown in equation (1)) for generating an LP-SS may also be associated with the index of the LP-SS set in the T LP-SS sets. For example, m=(n+id+a₁N_{ID}) mod a₂, where id is the index of the LP-SS set in the T LP-SS sets.

In some examples, N_{ID} as shown in equation (1) may also be associated with the index of the LP-SS set in the T LP-SS sets.

As such, the terminal device 120 can achieve and maintain the time synchronization with the network device 110 in a certain precision, and the terminal device 120 may further obtain and maintain the SFN. In this regard, the terminal device 120 may determine the timing for measure SSB and monitor paging quickly after waking up from the LP mode. It is to be understood that, comparing with SSB, it is not necessary for the LP-SS to provide very precise time domain synchronization since the OOK detection is more robust to time error. Therefore, compared to SSB, the time domain configuration for the LP-SS can be designed simplified.

The present disclosure may provide an acceptable precision for time synchronization based on the LP-SS, and the low complexity and low overhead at the terminal device 120 may be maintained.

In some example embodiments, the terminal device 120 may detect (or monitor) wake-up signals all the time, for example, utilizing the synchronization based on the received LP-SS. In some other example embodiments, in order to reduce power consumption, there is no need for the terminal device 120 to monitor the wake-up signals all the time.

In some example embodiments, an LP-WUS monitor window (window for short) may be configured to the terminal device 120. In some examples, a network device of a serving cell (the network device 110 or another network device) may transmit an indication of the window to the terminal device 120. And the terminal device 120 may only monitor LP-WUS within the window.

In some embodiments, the terminal device 120 may be configured with a length of the monitor window, where the length can be one or more system frames, sub-frames, slots, or milliseconds.

In some embodiments, the terminal device 120 may also be configured with an offset for the LP-WUS monitor window, where the offset indicates the time offset from the LP-SS and an LP-WUS monitor window.

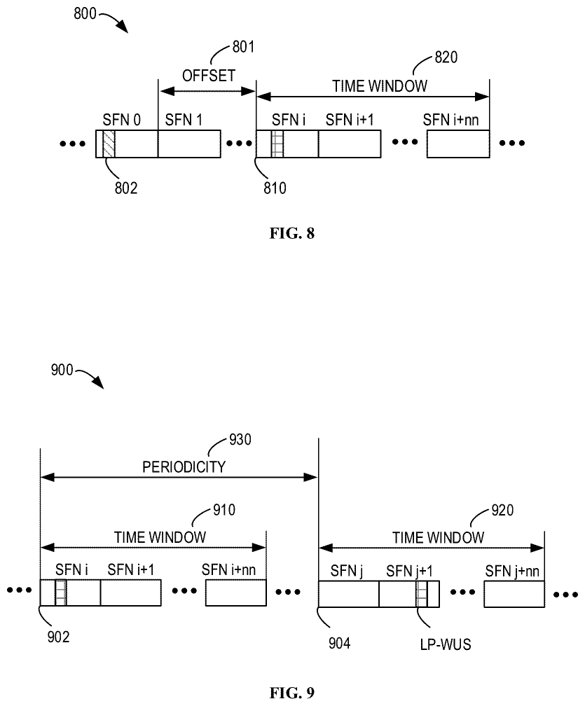

For better understanding, reference is now made to FIG. 8, which illustrates a schematic diagram of time window 800 for the LP-WUS according to some embodiments of the present disclosure. As shown in FIG. 8, a starting point 810 of the window may be determined based on an offset 801 of the window from the LP-SS 802. Additionally, the window 820 for monitoring the LP-WUS may be determined based on the starting point 810 and a length (nn frames as shown in FIG. 8).

In some example embodiments, the terminal device 120 may also be configured with a periodicity of the LP-WUS monitor window, which indicates the time duration between two adjacent LP-WUS monitoring windows. For better understanding, reference is now made to FIG. 9, which illustrates a schematic diagram of time window 900 for the LP-WUS according to some embodiments of the present disclosure. As shown in FIG. 9, a first window 910 is shown, and a second window 920 following the first window 910 may be determined based on the periodicity of the LP-WUS monitor window 930. For example, the time duration between the starting point 904 of the window 920 and the starting point 902 of the window 910 is indicated by the periodicity 930.

In some example embodiments, there may be a plurality of occasions in a window, and each occasion is associated with an LP-SS in an LP-SS set. In some examples, there may be N LP-SS signals in the LP-SS set and there may be N occasions in the window, and the ith occasion may be associated with the ith LP-SS signal, where N is an integer, i is an integer between 0 and N. As described above, the N LP-SS signals may be associated with N TX beams or be QCLed with N SSBs. And the terminal device 120 may assume that the LP-WUS is transmitted with a beam same as the associated LP-SS, or may assume that the LP-WUS is QCLed with the associated LP-SS, or may assume that the LP-WUS and the associated LP-SS are QCLed with a same SSB or CSI-RS resource.

In some examples, one occasion within the window may be configured, for example, one occasion may be indicated with a starting time and/or a duration. In some examples, the duration for an occasion may be less than a frame.

In some example embodiments, the terminal device 120 may blink detect the LP-WUS within the window, in other words, the terminal device 120 may assume that LP-WUS may appear at any occasion within the window.

According to the embodiments described with reference to FIG. 3 to FIG. 8, the time synchronization with the network side in a certain precision may be maintained based on the LP-SS, and the performance for detecting LP-WUS may be enhanced. As such, the efficiency may be improved and the overhead may be reduced.

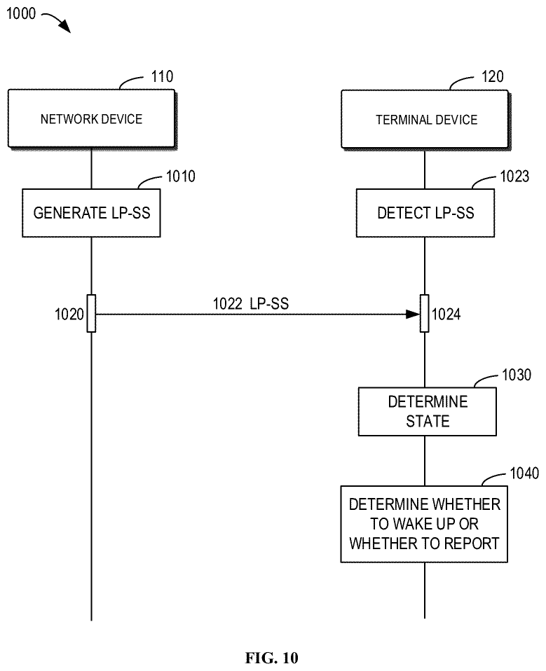

Reference is further made to FIG. 10, which illustrates a signalling chart illustrating communication process 1000 in accordance with some example embodiments of the present disclosure. Only for the purpose of discussion, the process 1000 will be described with reference to FIG. 1. The process 1000 may involve the terminal device 120, the network device 110 (for example the network device 110-1 or the network device 110-2).

The network device 110 generates 1010 an LP synchronization signal (LP-SS). In some embodiments, the LP-SS is different from a PSS or a SSS. It is to be understood that the description on operation 310 when referring to FIG. 3 may be applied to the operation 1010 in FIG. 10, and the similar disclosure will not be repeated herein.

The network device 110 transmits 1020 the LP-SS 1022 to a terminal device 120.

The terminal device 120 detects 1023 the LP-SS, and alternatively, the terminal device 120 receives 1024 the LP-SS 1022. The terminal device 120 determines 1030 a state of the terminal device 120 relative to a coverage of the LP-SS. The terminal device 120 determines 1040 whether to wake up from an LP mode or whether to report to the network device 110, based on the state of the terminal device 120.

In some example embodiments, the terminal device 120 may determine that the terminal device 120 is out of the coverage of the LP-SS based on at least one of: failing in receiving any LP-SS during a predefined duration, failing in receiving any LP-SS during a predefined number of continuous LP-SS monitoring occasions, the number of successfully received LP-SS during the predefined duration less than a threshold number, the number of successfully received LP-SS during the predefined number of continuous LP-SS monitoring occasions less than the threshold number, a received signal strength of the LP-SS lower than a threshold strength, a power ratio of on-symbols to off-symbols in the LP-SS lower than a threshold ratio, a signal to noise ratio (SNR) of the LP-SS lower than a threshold SNR, or receiving another LP-SS different from the LP-SS.

In some embodiments, the terminal device 120 may determines that it is located

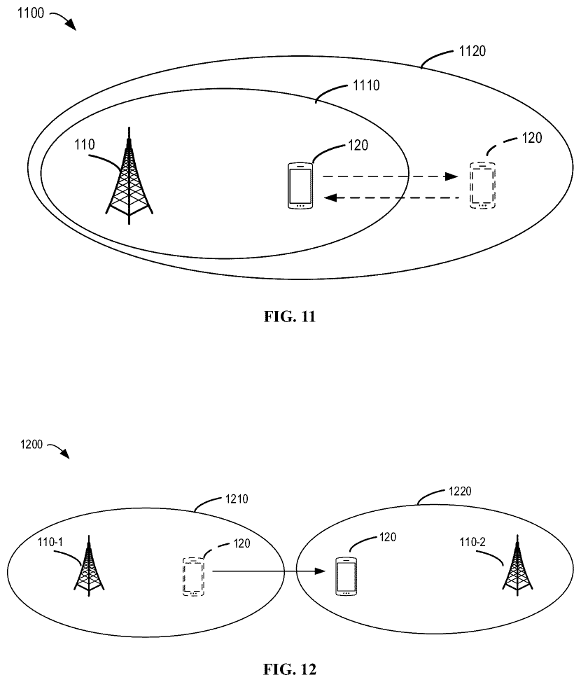

For better understanding, reference is now made to FIG. 11, which illustrates an example scenario 1100 according to some embodiments of the present disclosure. As shown in FIG. 11, the coverage 1110 of the LP-SS is smaller than a coverage 1120 for normal physical channels.

Typically, the inter-site distance is planned based on the coverage of the normal physical channels, e.g., physical broadcast channel (PBCH), physical random access channel (PRACH), PDCCH, PUCCH, etc., However, the coverage of LP signals may be worse than the normal physical channels due to the use of OOK modulation. Therefore, if the terminal device 120 moves to a coverage hole of the LP signals (for example, out of coverage 1010 in FIG. 10), it may be unable to receive the LP signals, and thus the terminal device 120 may need to be aware of the situation that it is out of coverage.

In the present disclosure, the LP-SS may be used to help the terminal device 120 to determine whether it is out of the coverage of the LP-SS.

In some example embodiments, the predefined duration may be represented as TO, and the predefined number of continuous LP-SS monitoring windows/occasions may be represented as N2. If the terminal device 120 fails to receive any LP-SS within TO or within N2 continuous LP-SS monitoring windows/occasions, the terminal device 120 may determine that it is out of the coverage of the LP-SS. For example, TO equals to multiple milliseconds or sub-frames, and N2 is an integer large than 0.

In some example embodiments, the predefined duration may be represented as TO1, the predefined number of continuous LP-SS monitoring windows/occasions may be represented as N21, and the threshold number may be represented as N22. If the terminal device 120 successfully receives N20 LP-SSs within T01 or within N21 continuous LP-SS monitoring windows/occasions, and N20<N22, the terminal device 120 may determine that it is out of the coverage of the LP-SS. For example, T01 equals to multiple milliseconds or sub-frames, and N22 is an integer large than 0. For example, T01=T0 and N21=N2. It is noted that the received N20 LP-SSs are not necessary to be continuous.

In some example embodiments, the terminal device 120 may measure the signal quality of the LP-SS, and determine whether it is out of the coverage of the LP-SS based on the measurement results. In some example embodiments, the measurement results may be at least one of the metrics: a receive signal strength indicator (RSSI), a power ratio, or an SNR.

In some embodiments, the RSSI may be an RSSI of LP-SS or LP-WUS. For example, the RSSI may be measured based on the signal strength of the OOK on-symbols in the LP signal (such as LP-SS). In some examples, the OOK off-symbols in the LP signal are not taken into account of the RSSI.

In some embodiments, the power ratio of the OOK on-symbols and OOK off-symbols in the LP signal (such as LP-SS) is determined based on the ratio of the average power of the OOK on-symbols to the average power of the OOK off-symbols. For example, the average power of OOK on-symbols may indicate the average value of the power of OOK on-symbols of an OOK sequence. For example, the average power of OOK off-symbol may indicate the average value of the power of OOK off-symbols of an OOK sequence. In some examples, the average power may also be filtered or averaged among multiple OOK sequences. In some examples, the average power may also be referred to as average energy/amplitude/strength.

In some embodiments, the SNR is determined based on the ratio of average power of the OOK symbols to the noise power, where the OOK symbols may include OOK on-symbols only, or may include OOK on-symbols and off-symbols.

In some example embodiments, if the terminal device 120 is in an LP mode and the terminal device 120 determines that it is out of the coverage of the LP-SS, the terminal device 120 may wake up from the LP mode. In some embodiments, the terminal device 120 may further transmit a report to the network device 110, where the report may indicate the measurement results discussed above.

In some examples, the terminal device 120 may stop monitoring the LP signals and enter into a normal operation in RRC idle/inactive state. For example, the terminal device 120 may be in a main mode. In some examples, the terminal device 120 may select a cell and start to monitor a paging message in the cell. For example, the terminal device 120 may monitor the paging occasions based on a paging configuration.

Alternatively, the terminal device 120 may start an initial access procedure after waking up from the LP mode. In some embodiments, if the cell the terminal device 120 selected after waking up from the LP mode has a TAC different from the cell before it get into LP mode, the terminal device 120 may start an initial access procedure. In some embodiments, if the cell the terminal device 120 selected after waking up from the LP mode has a same TAC as the cell before it get into LP mode, there is no need for the terminal device 120 to start the initial access procedure, and thus the communication efficiency may be improved.

As such, the terminal device 120 may determine whether it is out of the coverage and thus the terminal device 120 may wake up in time in case it is out of the coverage.

In some further example embodiments, the terminal device 120 may move from a first cell to a second cell, the LP-SS in the first cell is associated with a first ID, the LP-SS in the second cell is associated with a second ID, and the first ID is different from the second ID. Reference is now made to FIG. 12, which illustrates an example scenario 1200 according to some embodiments of the present disclosure. As shown in FIG. 12, the terminal device 120 may move from a cell 1210 to a cell 1220, and the cells 1210 and 1220 have different LP-SS configurations.

In some examples, the terminal device 120 may move from a cell/cell-group with LP-SS configuration 1 to a cell/cell-group with LP-SS configuration 2. In this case, since the network device 110 does not know the terminal device 120 has moved into a new area, the terminal device 120 may need to wake up and to perform an initial access procedure to inform the network its new location. Then network may page the terminal device 120 in the new cell or cell-group.

In some embodiments, the terminal device 120 may receive another LP-SS (also be called as a new LP-SS) different from a previous LP-SS, and the terminal device 120 may determine that it has moved into an area with a different LP-SS configuration. Referring to FIG. 12, the terminal device 120 moves from the cell 1210 to the cell 1220, and the terminal device 120 may receive an LP-SS from the cell 1220, and the new received LP-SS is different from a previous LP-SS from the cell 1210.

In some examples, the terminal device 120 may wake up from the LP mode, perform a cell search, and start an initial access procedure to the cell with the new LP-SS configuration, such as cell 1220 in FIG. 12.

In some embodiments, the terminal device 120 may determine that it has moved into an area with a different LP-SS configuration based on at least one of: failing in detecting any previous LP-SS during a pre-set duration, determining that the terminal device 120 is out of coverage of previous LP-SS, or determining that the new received LP-SS has a better quality than previous LP-SS. It is to be understood that the quality may be obtained by any one of RSSI, power ratio, SNR, average power, etc., and the present disclosure does not limit this aspect.

In some other embodiments, the terminal device 120 may determine whether to wake up according to its specific implementation (UE implementation), based on one or more LP-SSs it detected, where the one or more LP-SSs may or may not include previously configured LP-SS.

Based on the description stated above, the LP signals may be received by the terminal device 120 in an LP mode, thus the synchronization may be maintained with a certain precision and the detection performance may be enhanced. Additionally, the terminal device 120 may determine whether it is out of the coverage of the LP-SS or whether it has moved into a new area, a report may be transmitted to the network device 110, so that the network may aware of the state of the terminal device 120.

In some embodiments of the present disclosure, the LP-SS may also be used even the terminal device 120 is not in an LP mode.

In some embodiments, the terminal device 120 may be in an RRC connected mode. If the terminal device 120 is configured to measure the LP-SS, the terminal device 120 may be measure the detected LP-SS and transmit a report to the network device 110. In some examples, the report may include at least one measurement result based on the LP-SS and/or assistance information for configuring an LP mode or the LP-SS. As such, the network device 110 may receive the report, and the report may help the network device 110 to determine whether to configure the terminal device 120 to enter into the LP mode.

In some embodiments, the terminal device 120 may be in an RRC idle mode or an inactive mode. The terminal device 120 may measure the detected LP-SS (alternatively, the terminal device 120 may be configured to measure the LP-SS), and determines whether it is out of the coverage of the LP-SS. In some examples, the terminal device 120 may start an initial access procedure if the terminal device 120 is in the coverage of the LP-SS. Additionally, the terminal device 120 may transmit a report to the network device 110. In some examples, the report may include at least one measurement result based on the LP-SS and/or assistance information for configuring an LP mode or the LP-SS. In some examples, the report may be comprised in a message 3 or a message A transmitted during the initial access procedure. As such, the network device 110 may receive the report, and the report may help the network device 110 to determine whether to configure the terminal device 120 to enter into the LP mode.

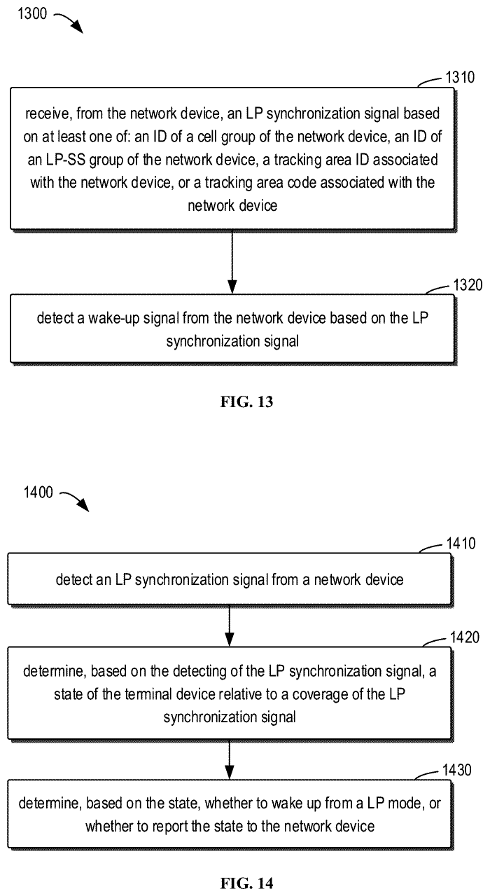

FIG. 13 illustrates a flowchart of an example method 1300 implemented at a terminal device in accordance with some embodiments of the present disclosure. For the purpose of discussion, the method 1300 will be described from the perspective of the terminal device 120 with reference to FIG. 1.

At block 1310, the terminal device 120 in an LP mode receives, from the network device 110, an LP synchronization signal based on at least one of: an ID of a cell group of the network device 110, an ID of an LP-SS group of the network device 110, a tracking area ID associated with the network device 110, or a tracking area code associated with the network device 110. At block 1320, the terminal device 120 detects a wake-up signal from the network device 110 based on the LP synchronization signal.

In some example embodiments, the LP synchronization signal comprises an amplitude modulation sequence.

In some example embodiments, the amplitude modulation sequence comprises at least one OOK on-symbol and at least one OOK off-symbol.

In some example embodiments, the LP synchronization signal is one of a plurality of signals associated with a plurality of transmit beams of the network device 110 or QCLed with a plurality of SSBs to be transmitted by the network device 110, respectively.

In some example embodiments, the plurality of signals are based on a common amplitude modulation sequence and are transmitted with different time resources.

In some example embodiments, the plurality of signals are based on different amplitude modulation sequences, and each of the plurality of signals is associated with at least one of: a sub-frame index, a slot index, or an index of the plurality of signals.

In some example embodiments, the wake-up signal informs the terminal device 120 of at least one of: staying in the LP mode, waking up from the LP mode, or a configuration of an LP synchronization signal to be transmitted by the network device 110.

In some example embodiments, the terminal device 120 determines a set of time resources for receiving the LP synchronization signal based on at least one of: a HFN, a transmission periodicity of the LP synchronization signal, a hyper frame offset, a frame offset, a sub-frame offset, or a slot offset.

In some example embodiments, the terminal device 120 receives, prior to entering the LP mode, an indication of an initial HFN in a serving cell; and determines the HFN based on the initial HFN.

In some example embodiments, the indication of the initial HFN is transmitted by one of: system information, RRC signalling, or a PDCP parameter.

In some example embodiments, the terminal device 120 determines an initial HFN based on an instant when control information is received by the terminal device 120, the control information indicating the terminal device 120 to enter the LP mode; and determines the HFN based on the initial HFN.

In some example embodiments, the transmission periodicity is equal to a plurality of hyper frames.

In some example embodiments, the transmission periodicity is equal to a plurality of frames, and the set of time resources are determined further based on an ID of the LP-SS group including the LP synchronization signal.

In some example embodiments, the terminal device 120 detects the wake-up signal comprises: detecting the wake-up signal at one of a plurality of occasions within a time window indicated by the network device 110.

In some example embodiments, the wake-up signal at the one of a plurality of occasions is associated with the LP synchronization signal in a plurality of signals, and wherein an order of the one of a plurality of occasions among the plurality of occasions is the same as an order of the LP synchronization signal in the plurality of signals.

In some example embodiments, the terminal device 120 enters the LP mode by switching off a main mode, where the terminal device 120 in the main mode performing at least one of: paging monitoring, cell selection or re-selection, measurements based on a primary synchronization signal (PSS), a secondary synchronization signal (SSS) or a channel state information-reference signal (CSI-RS), physical downlink control channel (PDCCH) monitoring, or uplink transmission.

In some example embodiments, the LP synchronization signal is different from a PSS or a SSS received in a main mode.

FIG. 14 illustrates a flowchart of an example method 1400 implemented at a terminal device in accordance with some embodiments of the present disclosure. For the purpose of discussion, the method 1400 will be described from the perspective of the terminal device 120 with reference to FIG. 1.

At block 1410, the terminal device 120 detects an LP synchronization signal from a network device 110. At block 1420, the terminal device 120 determines, based on the detecting of the LP synchronization signal, a state of the terminal device 120 relative to a coverage of the LP synchronization signal. At block 1430, the terminal device 120 determines, based on the state, whether to wake up from an LP mode or whether to report the state to the network device 110.

In some example embodiments, the terminal device 120 determines the state of the terminal device 120 comprises determining that the terminal device 120 is out of the coverage based on at least one of: failing in receiving any LP synchronization signal during a predefined duration, failing in receiving any LP synchronization signal during a predefined number of continuous LP synchronization signal monitoring occasions, the number of successfully received LP synchronization signals during the predefined duration less than a threshold number, the number of successfully received LP synchronization signals during the predefined number of continuous LP synchronization signal monitoring occasions less than the threshold number, a received signal strength of the LP synchronization signal lower than a threshold strength, a power ratio of on-symbols to off-symbols in the LP synchronization signal lower than a threshold ratio, a signal to noise ratio (SNR) of the LP synchronization signal lower than a threshold SNR, or receiving another LP synchronization signal different from the LP synchronization signal.

In some example embodiments, in accordance with a determination that the terminal device 120 is out of the coverage and is in an LP mode, the terminal device 120 wakes up from the LP mode.

In some example embodiments, in accordance with a determination that the terminal device 120 wakes up from the LP mode, the terminal device 120 selects a cell and monitors a paging message in the cell.

In some example embodiments, in accordance with a determination that the terminal device 120 wakes up from the LP mode, the terminal device 120 selects a cell; and in accordance with a determination that a first tracking area code associated with the selected cell is different from a second tracking area code associated with an initial cell in which before the terminal device 120 entering the LP mode, the terminal device 120 starts an initial access procedure.

In some example embodiments, in accordance with a determination that the terminal device 120 is configured to measure a detected LP synchronization signal and is in a RRC connected mode, the terminal device 120 transmits a report to the network device 110, where the report includes at least one of: a measurement result based on the LP synchronization signal, or assistance information for configuring an LP mode or the LP synchronization signal.

In some example embodiments, in accordance with a determination that the terminal device 120 is in the coverage and is in a RRC idle mode or an inactive mode, the terminal device 120 starts an initial access procedure.

In some example embodiments, the terminal device 120 transmits a report to the network device 110, the report including at least one of: a measurement result based on the LP synchronization signal, or assistance information for configuring an LP mode or the LP synchronization signal.

In some example embodiments, the report is comprised in a message 3 or a message A transmitted during the initial access procedure.

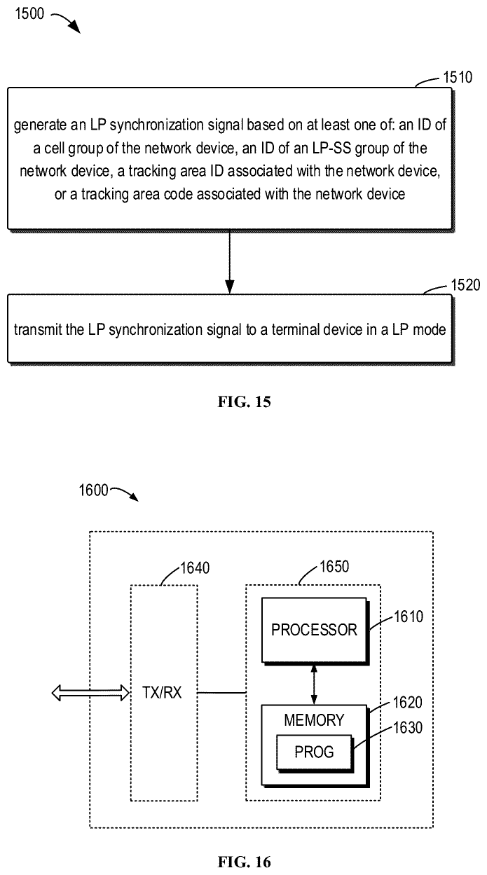

FIG. 15 illustrates a flowchart of an example method 1500 implemented at a network device in accordance with some embodiments of the present disclosure. For the purpose of discussion, the method 1500 will be described from the perspective of the network device 110 with reference to FIG. 1.

At block 1510, the network device 110 generates an LP synchronization signal based on at least one of: an ID of a cell group of the network device 110, an ID of an LP-SS group of the network device 110, a tracking area ID associated with the network device 110, or a tracking area code associated with the network device 110. At block 1520, the network device 110 transmits the LP synchronization signal to a terminal device 120 in an LP mode.

In some example embodiments, the LP synchronization signal comprises an amplitude modulation sequence.

In some example embodiments, the amplitude modulation sequence comprises at least one OOK on-symbol and at least one OOK off-symbol.

In some example embodiments, the LP synchronization signal is one of a plurality of signals associated with a plurality of transmit beams of the network device 110, or QCLed with a plurality of SSBs to be transmitted by the network device 110, respectively.

In some example embodiments, the plurality of signals are based on a common amplitude modulation sequence and are transmitted with different time resources.

In some example embodiments, the plurality of signals are based on different amplitude modulation sequences, and each of the plurality of signals is associated with at least one of: a sub-frame index, a slot index, or an index of the plurality of signals.

In some example embodiments, the network device 110 transmits a wake-up signal informing the terminal device 120 of at least one of: staying in the LP mode, waking up from the LP mode, or a configuration of an LP synchronization signal to be transmitted by the network device 110.

In some example embodiments, the network device 110 transmits the wake-up signal comprises: transmitting the wake-up signal at one of a plurality of occasions within a time window.

In some example embodiments, the wake-up signal at the one of a plurality of occasions is associated with the LP synchronization signal in a plurality of signals, and wherein an order of the one of a plurality of occasions among the plurality of occasions is the same as an order of the LP synchronization signal in the plurality of signals.

In some example embodiments, the network device 110 transmits, to the terminal device 120 in a main mode, an indication of an initial HFN.

In some example embodiments, the indication of the initial HFN is transmitted by one of: system information, radio resource control (RRC) signalling, or a packet data convergence protocol (PDCP) parameter.

In some example embodiments, a transmission periodicity of the LP synchronization signal is equal to a plurality of hyper frames or a plurality of frames.

In some example embodiments, the network device 110 receives a report from the terminal device 120, the report including at least one of: a measurement result based on the LP synchronization signal, or assistance information for configuring an LP mode or the LP synchronization signal.

In some example embodiments, the report is comprised in a message 3 or a message A transmitted during an initial access procedure started by the terminal device 120.

In some example embodiments, the LP synchronization signal is different from a PSS or a SSS received in a main mode.

Details of some embodiments according to the present disclosure have been described with reference to FIGS. 1-15. Now an example implementation of the terminal device and the network device will be discussed below.

In some example embodiments, a terminal device comprises circuitry configured to: receive, in an LP mode and from the network device, an LP synchronization signal based on at least one of: an ID of a cell group of the network device, an ID of an LP-SS group of the network device, a tracking area ID associated with the network device, or a tracking area code associated with the network device; and detect a wake-up signal from the network device based on the LP synchronization signal.

In some example embodiments, the LP synchronization signal comprises an amplitude modulation sequence.

In some example embodiments, the amplitude modulation sequence comprises at least one OOK on-symbol and at least one OOK off-symbol.

In some example embodiments, the LP synchronization signal is one of a plurality of signals associated with a plurality of transmit beams of the network device or QCLed with a plurality of SSBs to be transmitted by the network device, respectively.

In some example embodiments, the plurality of signals are based on a common amplitude modulation sequence and are transmitted with different time resources.

In some example embodiments, the plurality of signals are based on different amplitude modulation sequences, and each of the plurality of signals is associated with at least one of: a sub-frame index, a slot index, or an index of the plurality of signals.

In some example embodiments, the wake-up signal informs the terminal device of at least one of: staying in the LP mode, waking up from the LP mode, or a configuration of an LP synchronization signal to be transmitted by the network device.

In some example embodiments, a terminal device comprises circuitry configured to determine a set of time resources for receiving the LP synchronization signal based on at least one of: a HFN, a transmission periodicity of the LP synchronization signal, a hyper frame offset, a frame offset, a sub-frame offset, or a slot offset.

In some example embodiments, a terminal device comprises circuitry configured to receive, prior to entering the LP mode, an indication of an initial HFN in a serving cell; and determines the HFN based on the initial HFN.

In some example embodiments, the indication of the initial HFN is transmitted by one of: system information, RRC signalling, or a PDCP parameter.

In some example embodiments, a terminal device comprises circuitry configured to determine an initial HFN based on an instant when control information is received by the terminal device, the control information indicating the terminal device to enter the LP mode; and determine the HFN based on the initial HFN.

In some example embodiments, the transmission periodicity is equal to a plurality of hyper frames.

In some example embodiments, the transmission periodicity is equal to a plurality of frames, and the set of time resources are determined further based on the ID of the LP-SS group including the LP synchronization signal.

In some example embodiments, a terminal device comprises circuitry configured to detect the wake-up signal at one of a plurality of occasions within a time window indicated by the network device.

In some example embodiments, the wake-up signal at the one of a plurality of occasions is associated with the LP synchronization signal in a plurality of signals, and wherein an order of the one of a plurality of occasions among the plurality of occasions is the same as an order of the LP synchronization signal in the plurality of signals.

In some example embodiments, the terminal device comprises circuitry configured to enter the LP mode by switching off a main mode, where the terminal device in the main mode performing at least one of: paging monitoring, cell selection or re-selection, measurements based on a primary synchronization signal (PSS), a secondary synchronization signal (SSS) or a channel state information-reference signal (CSI-RS), physical downlink control channel (PDCCH) monitoring, or uplink transmission.

In some example embodiments, the LP synchronization signal is different from a PSS or a SSS received in a main mode.

In some example embodiments, a terminal device comprises circuitry configured to: detect an LP synchronization signal from a network device; determine, based on the detecting of the LP synchronization signal, a state of the terminal device relative to a coverage of the LP synchronization signal; and determine, based on the state, whether to wake up from an LP mode or whether to report the state to the network device.

In some example embodiments, the terminal device comprises circuitry configured to determine that the terminal device is out of the coverage based on at least one of: failing in receiving any LP synchronization signal during a predefined duration, failing in receiving any LP synchronization signal during a predefined number of continuous LP synchronization signal monitoring occasions, the number of successfully received LP synchronization signals during the predefined duration less than a threshold number, the number of successfully received LP synchronization signals during the predefined number of continuous LP synchronization signal monitoring occasions less than the threshold number, a received signal strength of the LP synchronization signal lower than a threshold strength, a power ratio of on-symbols to off-symbols in the LP synchronization signal lower than a threshold ratio, a signal to noise ratio (SNR) of the LP synchronization signal lower than a threshold SNR, or receiving another LP synchronization signal different from the LP synchronization signal.

In some example embodiments, the terminal device comprises circuitry configured to: in accordance with a determination that the terminal device is out of the coverage and is in an LP mode, wake up from the LP mode.

In some example embodiments, the terminal device comprises circuitry configured to: in accordance with a determination that the terminal device wakes up from the LP mode, select a cell and monitor a paging message in the cell.

In some example embodiments, the terminal device comprises circuitry configured to: in accordance with a determination that the terminal device wakes up from the LP mode, select a cell; and in accordance with a determination that a first tracking area code associated with the selected cell is different from a second tracking area code associated with an initial cell in which before the terminal device entering the LP mode, start an initial access procedure.

In some example embodiments, the terminal device comprises circuitry configured to: in accordance with a determination that the terminal device is configured to measure a detected LP synchronization signal and is in a RRC connected mode, transmit a report to the network device, where the report includes at least one of: a measurement result based on the LP synchronization signal, or assistance information for configuring an LP mode or the LP synchronization signal.

In some example embodiments, the terminal device comprises circuitry configured to: in accordance with a determination that the terminal device is in the coverage and is in a RRC idle mode or an inactive mode, start an initial access procedure.

In some example embodiments, the terminal device comprises circuitry configured to: transmit a report to the network device, the report including at least one of: a measurement result based on the LP synchronization signal, or assistance information for configuring an LP mode or the LP synchronization signal.

In some example embodiments, the report is comprised in a message 3 or a message A transmitted during the initial access procedure.

In some example embodiments, a network device comprises circuitry configured to: generate an LP synchronization signal based on at least one of: an ID of a cell group of the network device, an ID of an LP-SS group of the network device, a tracking area ID associated with the network device, or a tracking area code associated with the network device; and transmit the LP synchronization signal to a terminal device in an LP mode.

In some example embodiments, the LP synchronization signal comprises an amplitude modulation sequence.

In some example embodiments, the amplitude modulation sequence comprises at least one OOK on-symbol and at least one OOK off-symbol.

In some example embodiments, the LP synchronization signal is one of a plurality of signals associated with a plurality of transmit beams of the network device, or QCLed with a plurality of SSBs to be transmitted by the network device, respectively.

In some example embodiments, the plurality of signals are based on a common amplitude modulation sequence and are transmitted with different time resources.

In some example embodiments, the plurality of signals are based on different amplitude modulation sequences, and each of the plurality of signals is associated with at least one of: a sub-frame index, a slot index, or an index of the plurality of signals.

In some example embodiments, the network device comprises circuitry configured to: transmit a wake-up signal informing the terminal device of at least one of: staying in the LP mode, waking up from the LP mode, or a configuration of an LP synchronization signal to be transmitted by the network device.

In some example embodiments, the network device comprises circuitry configured to transmit the wake-up signal at one of a plurality of occasions within a time window.

In some example embodiments, the wake-up signal at the one of a plurality of occasions is associated with the LP synchronization signal in a plurality of signals, and wherein an order of the one of a plurality of occasions among the plurality of occasions is the same as an order of the LP synchronization signal in the plurality of signals.

In some example embodiments, the network device comprises circuitry configured to transmit, to the terminal device in a main mode, an indication of an initial HFN.

In some example embodiments, the indication of the initial HFN is transmitted by one of: system information, radio resource control (RRC) signalling, or a packet data convergence protocol (PDCP) parameter.

In some example embodiments, a transmission periodicity of the LP synchronization signal is equal to a plurality of hyper frames or a plurality of frames.

In some example embodiments, the network device comprises circuitry configured to receive a report from the terminal device, the report including at least one of: a measurement result based on the LP synchronization signal, or assistance information for configuring an LP mode or the LP synchronization signal.

In some example embodiments, the report is comprised in a message 3 or a message A transmitted during an initial access procedure started by the terminal device.

In some example embodiments, the LP synchronization signal is different from a PSS or a SSS received in a main mode.

FIG. 16 illustrates a simplified block diagram of a device 1600 that is suitable for implementing embodiments of the present disclosure. The device 1600 can be considered as a further example implementation of the terminal device 120, and the network device 110 as shown in FIG. 1. Accordingly, the device 1600 can be implemented at or as at least a part of the terminal device 120, or the network device 110.

As shown, the device 1600 includes a processor 1610, a memory 1620 coupled to the processor 1610, a suitable transmitter (TX) and receiver (RX) 1640 coupled to the processor 1610, and a communication interface coupled to the TX/RX 1640. The memory 1610 stores at least a part of a program 1630. The TX/RX 1640 is for bidirectional communications. The TX/RX 1640 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1630 is assumed to include program instructions that, when executed by the associated processor 1610, enable the device 1600 to operate in accordance with the embodiments of the present disclosure, as discussed herein with reference to FIGS. 2-10. The embodiments herein may be implemented by computer software executable by the processor 1610 of the device 1600, or by hardware, or by a combination of software and hardware. The processor 1610 may be configured to implement various embodiments of the present disclosure. Furthermore, a combination of the processor 1610 and memory 1620 may form processing means 1650 adapted to implement various embodiments of the present disclosure.

The memory 1620 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1620 is shown in the device 1600, there may be several physically distinct memory modules in the device 1600. The processor 1610 may be of any type suitable to the local technical network, and may include one or more of general purpose computers, special purpose computers, microprocessors, digital signal processors (DSPs) and processors based on multicore processor architecture, as non-limiting examples. The device 1600 may have multiple processors, such as an application specific integrated circuit chip that is slaved in time to a clock which synchronizes the main processor.

In summary, embodiments of the present disclosure may provide the following solutions.

The present disclosure provides a method of communication, comprises: receiving, at a terminal device in a low power (LP) mode and from a network device, an LP synchronization signal based on at least one of: an identity (ID) of a cell group of the network device, an ID of an LP-SS group of the network device, a tracking area ID associated with the network device, or a tracking area code associated with the network device; and detecting a wake-up signal from the network device based on the LP synchronization signal.

In one embodiment, the method as above, the LP synchronization signal comprises an amplitude modulation sequence.

In one embodiment, the method as above, the amplitude modulation sequence comprises at least one on-off keying (OOK) on-symbol and at least one OOK off-symbol.

In one embodiment, the method as above, the LP synchronization signal is one of a plurality of signals associated with a plurality of transmit beams of the network device or Quasi-Co-Located (QCLed) with a plurality of synchronization signal blocks (SSB) to be transmitted by the network device, respectively.

In one embodiment, the method as above, the plurality of signals are based on a common amplitude modulation sequence and are transmitted with different time resources.

In one embodiment, the method as above, the plurality of signals are based on different amplitude modulation sequences, and each of the plurality of signals is associated with at least one of: a sub-frame index, a slot index, or an index of the plurality of signals.

In one embodiment, the method as above, the wake-up signal informs the terminal device of at least one of: staying in the LP mode, waking up from the LP mode, or a configuration of an LP synchronization signal to be transmitted by the network device.

In one embodiment, the method as above, further comprising: determining a set of time resources for receiving the LP synchronization signal based on at least one of: a hyper frame number (HFN), a transmission periodicity of the LP synchronization signal, a hyper frame offset, a frame offset, a sub-frame offset, or a slot offset.

In one embodiment, the method as above, further comprising: receiving, prior to entering the LP mode, an indication of an initial HFN in a serving cell; and determining the HFN based on the initial HFN.

In one embodiment, the method as above, the indication of the initial HFN is transmitted by one of: system information, radio resource control (RRC) signalling, or a packet data convergence protocol (PDCP) parameter.

In one embodiment, the method as above, further comprising: determining an initial HFN based on an instant when control information is received by the terminal device, the control information indicating the terminal device to enter the LP mode; and determining the HFN based on the initial HFN.

In one embodiment, the method as above, the transmission periodicity is equal to a plurality of hyper frames.

In one embodiment, the method as above, the transmission periodicity is equal to a plurality of frames, and the set of time resources are determined further based on the ID of the LP-SS group including the LP synchronization signal.

In one embodiment, the method as above, detecting the wake-up signal comprises: detecting the wake-up signal at one of a plurality of occasions within a time window indicated by the network device.

In one embodiment, the method as above, the wake-up signal at the one of a plurality of occasions is associated with the LP synchronization signal in a plurality of signals, and wherein an order of the one of a plurality of occasions among the plurality of occasions is the same as an order of the LP synchronization signal in the plurality of signals.

In one embodiment, the method as above, further comprising: entering the LP mode by switching off a main mode, wherein the terminal device in the main mode performing at least one of: paging monitoring, cell selection or re-selection, measurements based on a primary synchronization signal (PSS), a secondary synchronization signal (SSS) or a channel state information-reference signal (CSI-RS), physical downlink control channel (PDCCH) monitoring, or uplink transmission.

In one embodiment, the method as above, the LP synchronization signal is different from a PSS or a SSS received in a main mode.

The present disclosure provides a method of communication, comprises: detecting, at a terminal device, a low power (LP) synchronization signal from a network device; determining, based on the detecting of the LP synchronization signal, a state of the terminal device relative to a coverage of the LP synchronization signal; and determining, based on the state, whether to wake up from an LP mode or whether to report the state to the network device.

In one embodiment, the method as above, determining the state of the terminal device comprises determining that the terminal device is out of the coverage based on at least one of: failing in receiving any LP synchronization signal during a predefined duration, failing in receiving any LP synchronization signal during a predefined number of continuous LP synchronization signal monitoring occasions, the number of successfully received LP synchronization signals during the predefined duration less than a threshold number, the number of successfully received LP synchronization signals during the predefined number of continuous LP synchronization signal monitoring occasions less than the threshold number, a received signal strength of the LP synchronization signal lower than a threshold strength, a power ratio of on-symbols to off-symbols in the LP synchronization signal lower than a threshold ratio, a signal to noise ratio (SNR) of the LP synchronization signal lower than a threshold SNR, or receiving another LP synchronization signal different from the LP synchronization signal.

In one embodiment, the method as above, further comprising: in accordance with a determination that the terminal device is out of the coverage and is in an LP mode, waking up from the LP mode.

In one embodiment, the method as above, further comprising: in accordance with a determination that the terminal device wakes up from the LP mode, selecting a cell; and monitoring a paging message in the cell.

In one embodiment, the method as above, further comprising: in accordance with a determination that the terminal device wakes up from the LP mode, selecting a cell; and in accordance with a determination that a first tracking area code associated with the selected cell is different from a second tracking area code associated with an initial cell in which before the terminal device entering the LP mode, starting an initial access procedure.

In one embodiment, the method as above, further comprising: in accordance with a determination that the terminal device is configured to measure a detected LP synchronization signal and is in a RRC connected mode, transmitting a report to the network device, the report including at least one of: a measurement result based on the LP synchronization signal, or assistance information for configuring an LP mode or the LP synchronization signal.

In one embodiment, the method as above, further comprising: in accordance with a determination that the terminal device is in the coverage and is in a RRC idle mode or an inactive mode, starting an initial access procedure.

In one embodiment, the method as above, further comprising: transmitting a report to the network device, the report including at least one of: a measurement result based on the LP synchronization signal, or assistance information for configuring an LP mode or the LP synchronization signal.

In one embodiment, the method as above, the report is comprised in a message 3 or a message A transmitted during the initial access procedure.

The present disclosure provides a method of communication, comprises: generating, at a network device, a low power (LP) synchronization signal based on at least one of: an identity (ID) of a cell group of the network device, an ID of an LP-SS group of the network device, a tracking area ID associated with the network device, or a tracking area code associated with the network device; and transmitting the LP synchronization signal to a terminal device in an LP mode.

In one embodiment, the method as above, the LP synchronization signal comprises an amplitude modulation sequence.

In one embodiment, the method as above, the amplitude modulation sequence comprises at least one on-off keying (OOK) on-symbol and at least one OOK off-symbol.

In one embodiment, the method as above, the LP synchronization signal is one of a plurality of signals associated with a plurality of transmit beams of the network device, or Quasi-Co-Located (QCLed) with a plurality of synchronization signal blocks (SSB) to be transmitted by the network device, respectively.

In one embodiment, the method as above, the plurality of signals are based on a common amplitude modulation sequence and are transmitted with different time resources.

In one embodiment, the method as above, the plurality of signals are based on different amplitude modulation sequences, and each of the plurality of signals is associated with at least one of: a sub-frame index, a slot index, or an index of the plurality of signals.

In one embodiment, the method as above, further comprising: transmitting a wake-up signal informing the terminal device of at least one of: staying in the LP mode, waking up from the LP mode, or a configuration of an LP synchronization signal to be transmitted by the network device.

In one embodiment, the method as above, transmitting the wake-up signal comprises: transmitting the wake-up signal at one of a plurality of occasions within a time window.

In one embodiment, the method as above, the wake-up signal at the one of a plurality of occasions is associated with the LP synchronization signal in a plurality of signals, and wherein an order of the one of a plurality of occasions among the plurality of occasions is the same as an order of the LP synchronization signal in the plurality of signals.

In one embodiment, the method as above, further comprising: transmitting, to the terminal device in a main mode, an indication of an initial HFN.

In one embodiment, the method as above, the indication of the initial HFN is transmitted by one of: system information, radio resource control (RRC) signalling, or a packet data convergence protocol (PDCP) parameter.

In one embodiment, the method as above, a transmission periodicity of the LP synchronization signal is equal to a plurality of hyper frames or a plurality of frames.

In one embodiment, the method as above, further comprising: receiving a report from the terminal device, the report including at least one of: a measurement result based on the LP synchronization signal, or assistance information for configuring an LP mode or the LP synchronization signal.

In one embodiment, the method as above, the report is comprised in a message 3 or a message A transmitted during an initial access procedure started by the terminal device.

In one embodiment, the method as above, the LP synchronization signal is different from a PSS or a SSS received in a main mode.

The present disclosure provides a terminal device, comprising: a processor; and a memory storing computer program codes; the memory and the computer program codes configured to, with the processor, cause the terminal device to perform the method implemented at the terminal device discussed above.

The present disclosure provides a network device, comprising: a processor; and a memory storing computer program codes; the memory and the computer program codes configured to, with the processor, cause the network device to perform the method implemented at the network device discussed above.

The present disclosure provides a computer readable medium having instructions stored thereon, the instructions, when executed by a processor of an apparatus, causing the apparatus to perform the method implemented at a terminal device or a network device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3-15. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method of communication performed by a terminal device, comprising:
receiving, in a low power (LP) mode and from a network device, an LP synchronization signal;
monitoring a low power wake-up signal (LP-WUS) from the network device based on the LP synchronization signal; and
exiting LP-WUS monitoring in a case where a received signal power of the LP synchronization signal is lower than a threshold, wherein the received signal power of the LP synchronization signal is determined based on a power of the OOK on-symbols in the LP synchronization signal.

22. The method of claim 21, wherein the LP synchronization signal is generated based on at least one of:
an identity (ID) of a cell group of the network device,
an ID of an LP synchronization signal group of the network device,
a tracking area ID associated with the network device, or
a tracking area code associated with the network device.

23. A method of communication performed by a terminal device, comprising:
detecting a low power (LP) synchronization signal from a network device;
determining, based on the detecting of the LP synchronization signal, a state of the terminal device relative to a coverage of the LP synchronization signal; and
determining, based on the state, whether to wake up from an LP mode or whether to report the state to the network device.

24. The method of claim 23, wherein determining the state of the terminal device comprises determining that the terminal device is out of the coverage based on at least one of:
failing in receiving any LP synchronization signal during a predefined duration,
failing in receiving any LP synchronization signal during a predefined number of continuous LP synchronization signal monitoring occasions,
the number of successfully received LP synchronization signals during the predefined duration less than a threshold number,
the number of successfully received LP synchronization signals during the predefined number of continuous LP synchronization signal monitoring occasions less than the threshold number,
a received signal strength of the LP synchronization signal lower than a threshold strength,
a power ratio of on-symbols to off-symbols in the LP synchronization signal lower than a threshold ratio,
a signal to noise ratio (SNR) of the LP synchronization signal lower than a threshold SNR, or
receiving another LP synchronization signal different from the LP synchronization signal.

25. The method of claim 23, further comprising:
waking up from the LP mode in a case where the terminal device is out of the coverage and is in an LP mode.

26. The method of claim 25, further comprising:
selecting a cell in a case where the terminal device wakes up from the LP mode; and
monitoring a paging message in the cell.

27. The method of claim 24, further comprising:
selecting a cell in a case where the terminal device wakes up from the LP mode; and
starting an initial access procedure in a case where a first tracking area code associated with the selected cell is different from a second tracking area code associated with an initial cell in which before the terminal device entering the LP mode.

28. The method of claim 23, further comprising:
transmitting, to the network device, a report in a case where the terminal device is configured to measure a detected LP synchronization signal and is in a RRC connected mode, the report including at least one of:
a measurement result based on the LP synchronization signal, or
assistance information for configuring an LP mode or the LP synchronization signal.

29. The method of claim 23, further comprising:
starting an initial access procedure in a case where the terminal device is in the coverage and is in a RRC idle mode or an inactive mode.

30. The method of claim 29, further comprising:
transmitting a report to the network device, the report including at least one of:
a measurement result based on the LP synchronization signal, or
assistance information for configuring an LP mode or the LP synchronization signal.

31. The method of claim 30, wherein the report is comprised in a message 3 or a message A transmitted during the initial access procedure.

32. A method of communication performed by a network device, comprising:
generating a low power (LP) synchronization signal
transmitting, to a terminal device, a low power wake-up signal (LP-WUS) based on the LP synchronization signal in an LP mode, wherein the LP synchronization signal is used for the terminal device to exit LP-WUS monitoring in a case where a received signal power of the LP synchronization signal is lower than a threshold, the received signal power of the LP synchronization signal is determined based on a power of the OOK on-symbols in the LP synchronization signal.

33. The method of claim 32, wherein the LP synchronization signal is generated based on at least one of:
an identity (ID) of a cell group of the network device,
an ID of an LP synchronization signal group of the network device,
a tracking area ID associated with the network device, or
a tracking area code associated with the network device.

34. The method of claim 32, wherein the LP synchronization signal is one of a plurality of signals associated with a plurality of transmit beams of the network device, or Quasi-Co-Located (QCLed) with a plurality of synchronization signal blocks (SSB) to be transmitted by the network device, respectively.

35. The method of claim 32, further comprising:
transmitting a wake-up signal informing the terminal device of at least one of:
staying in the LP mode,
waking up from the LP mode, or
a configuration of an LP synchronization signal to be transmitted by the network device.

36. The method of claim 35, wherein transmitting the wake-up signal comprises:
transmitting the wake-up signal at one of a plurality of occasions within a time window,
wherein the wake-up signal at the one of a plurality of occasions is associated with the LP synchronization signal in a plurality of signals, and wherein an order of the one of a plurality of occasions among the plurality of occasions is the same as an order of the LP synchronization signal in the plurality of signals.

37. The method of claim 32, further comprising:
receiving a report from the terminal device, the report including at least one of:
a measurement result based on the LP synchronization signal, or
assistance information for configuring an LP mode or the LP synchronization signal.

38. The method of claim 37, wherein the report is comprised in a message 3 or a message A transmitted during an initial access procedure started by the terminal device.

39. The method of claim 32, wherein the LP synchronization signal is different from a PSS or a SSS received in a main mode.

40. A terminal device comprising:
a processor configured to cause the terminal device to:
receive, in a low power (LP) mode and from a network device, an LP synchronization signal;
monitor a wake-up signal from the network device based on the LP synchronization signal; and
exit LP-WUS monitoring in a case where a received signal power of the LP synchronization signal is lower than a threshold, wherein the received signal power of the LP synchronization signal is determined based on a power of the OOK on-symbols in the LP synchronization signal.
